(19) United States
(12) Patent Application Publication
(10) Pub. No.: US 2025/0208555 A1
(43) Pub. Date: Jun. 26, 2025

(54) ELECTRONIC APPARATUS, ANOMALY DETECTION SYSTEM, AND ANOMALY DETECTION METHOD

(71) Applicant: Keitaro SHOJI, KANAGAWA (JP)

(72) Inventor: Keitaro SHOJI, KANAGAWA (JP)

(21) Appl. No.: 18/981,657

(22) Filed: Dec. 16, 2024

(30) Foreign Application Priority Data
Dec. 25, 2023 (JP) 2023-218569

(51) Int. Cl. G03G 15/00; G03G 15/20

(52) U.S. Cl. CPC G03G 15/55; G03G 15/2039; G03G 15/5008; G03G 15/5012; G03G 2215/00037

(57) ABSTRACT

An electronic apparatus includes a sensor that outputs sensor values and processing circuitry that retrieves time series data obtained by collecting the sensor values from the sensor over time. The processing circuitry detects an abnormality based on the retrieved time series data and a predetermined rule determined in advance. The processing circuitry inputs the retrieved time series data to a learned model that defines the time series data as input data and information indicating a type of the abnormality as output data. The processing circuitry obtains the information indicating the type of the abnormality from the learned model. The processing circuitry controls operation of the electronic apparatus based on the information indicating the type of the abnormality.

### CROSS-REFERENCE TO RELATED APPLICATION

This patent application is based on and claims priority pursuant to 35 U.S.C. § 119(a) to Japanese Patent Application No. 2023-218569, filed on Dec. 25, 2023, in the Japan Patent Office, the entire disclosure of which is hereby incorporated by reference herein.

### BACKGROUND

### Technical Field

Embodiments of this disclosure relate to an electronic apparatus, an anomaly detection system, and an anomaly detection method, and more particularly, to an electronic apparatus, an anomaly detection system incorporating the electronic apparatus, and an anomaly detection method performed by the electronic apparatus.

### Related Art

Related-art electronic apparatuses present solutions to address an error that is detected. As one example, based on a dataset that correlates error information and operation information of the electronic apparatus to solution information to address an error, the electronic apparatus presents a solution suggested to address the error by using a learned model obtained by machine learning of conditions for solutions suggested to address the error.

However, for example, in a case that the detected error requests an instant control such as interruption of operation of the electronic apparatus as a solution, the solution may not address the error.

### SUMMARY

This specification describes below an improved electronic apparatus. In one embodiment, the electronic apparatus includes a sensor that outputs sensor values and processing circuitry that retrieves time series data obtained by collecting the sensor values from the sensor over time. The processing circuitry detects an abnormality based on the retrieved time series data and a predetermined rule determined in advance. The processing circuitry inputs the retrieved time series data to a learned model that defines the time series data as input data and information indicating a type of the abnormality as output data. The processing circuitry obtains the information indicating the type of the abnormality from the learned model. The processing circuitry controls operation of the electronic apparatus based on the information indicating the type of the abnormality.

This specification further describes an improved anomaly detection system. In one embodiment, the anomaly detection system includes an information processing device that generates a learned model and an electronic apparatus that includes a sensor that outputs sensor values and processing circuitry that retrieves time series data obtained by collecting the sensor values from the sensor over time. The processing circuitry detects an abnormality based on the retrieved time series data and a predetermined rule determined in advance. The processing circuitry sends the time series data to the information processing device in a case that the processing circuitry detects the abnormality. The processing circuitry inputs the time series data to the learned model that defines the time series data as input data and information indicating a type of the abnormality as output data. The processing circuitry obtains the information indicating the type of the abnormality from the learned model. The processing circuitry controls operation of the electronic apparatus based on the information indicating the type of the abnormality.

This specification further describes an improved anomaly detection method performed by an electronic apparatus. In one embodiment, the anomaly detection method includes retrieving time series data obtained by collecting sensor values output from a sensor over time and detecting an abnormality based on the retrieved time series data and a predetermined rule determined in advance. The anomaly detection method further includes inputting the retrieved time series data to a learned model that defines the time series data as input data and information indicating a type of the abnormality as output data. The anomaly detection method further includes obtaining the information indicating the type of the abnormality from the learned model. The anomaly detection method further includes controlling operation of the electronic apparatus based on the obtained information indicating the type of the abnormality.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a schematic cross-sectional view of an image forming apparatus according to an embodiment of the present disclosure, illustrating a construction of the image forming apparatus;

FIG. 1B is a partially enlarged cross-sectional view of the image forming apparatus depicted in FIG. 1A;

FIG. 2 is a block diagram of an image forming system incorporating the image forming apparatus depicted in FIG. 1A, illustrating a system configuration of the image forming system;

FIG. 3A is a block diagram of the image forming apparatus depicted in FIG. 1A, illustrating a hardware configuration thereof,

FIG. 3B is a block diagram of a machine learning server incorporated in the image forming system depicted in FIG. 2, illustrating a hardware configuration of the machine learning server;

FIG. 4 is a block diagram of the image forming system depicted in FIG. 2, illustrating a functional configuration of functional units of the image forming system;

FIG. 5A is a first illustration of a machine learning unit incorporated in the machine learning server of the image forming system depicted in FIG. 4, illustrating an input-output configuration using a learning model;

FIG. 5B is a second illustration of the machine learning unit incorporated in the machine learning server of the image forming system depicted in FIG. 4, illustrating the input-output configuration using the learning model;

FIG. 6 is a sequence diagram of the image forming system depicted in FIG. 2, illustrating operation thereof,

FIG. 7 is a flowchart of processes performed by the image forming apparatus depicted in FIG. 1A; and

FIG. 8 is a block diagram of an image forming apparatus according to another embodiment of the present disclosure, illustrating a functional configuration thereof.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to the drawings, the following describes embodiments of the present disclosure.

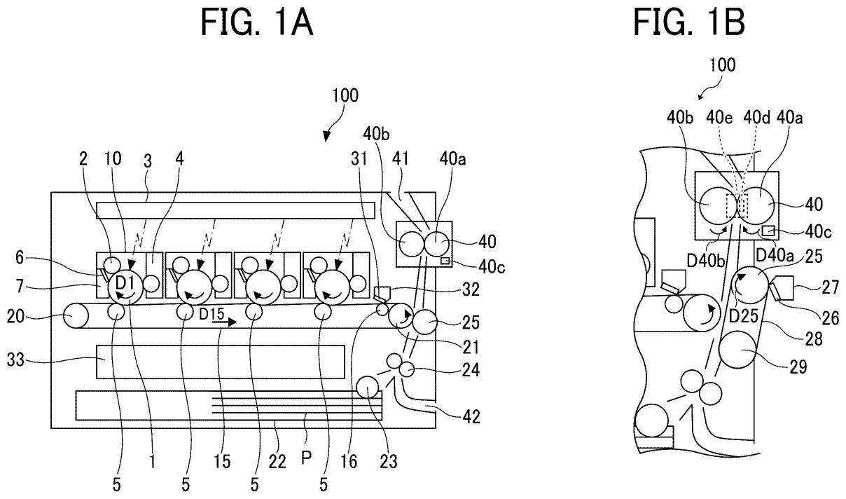

FIGS. 1A and 1B schematically illustrate a construction of an image forming apparatus 100 according to an embodiment of the present disclosure. FIG. 1A illustrates a configuration of a secondary transfer roller 25. FIG. 1B illustrates a configuration of a secondary transfer belt 28.

The image forming apparatus 100 according to the embodiment is one example of an electronic apparatus.

The image forming apparatus 100 according to the embodiment includes four process units 10, an exposure device 3, and primary transfer rollers 5. Each of the process units 10 includes a photoconductive drum 1, a charger 2, a developing device 4, and a photoconductive drum cleaning unit 7. The image forming apparatus 100 further includes a transfer belt 15, a cleaning unit opposed roller 16, a tension roller 20, a transfer belt driving roller 21, a transfer sheet tray 22, a feed roller 23, a registration roller pair 24, the secondary transfer roller 25, a cleaning blade 26, a secondary transfer roller cleaning unit 27, the secondary transfer belt 28, and a tension roller 29.

The image forming apparatus 100 further includes a cleaning blade 31, a transfer belt cleaning unit 32, a waste toner container 33, a fixing device 40, a discharge slot 41, and a bypass slot 42.

The photoconductive drum 1 is tubular and rotates clockwise in FIG. 1A in a rotation direction D1. The charger 2 is a roller that presses against the photoconductive drum 1 and charges a surface of the photoconductive drum 1. The charger 2 rotates in accordance with rotation of the photoconductive drum 1. The image forming apparatus 100 further includes a high voltage power supply that supplies a bias voltage, that is, a direct current voltage or a voltage generated by superimposing an alternating current voltage on a direct current voltage, to the charger 2. The charger 2 applies the bias voltage to the photoconductive drum 1, uniformly charging the surface of the photoconductive drum 1. The charger 2 according to the embodiment employs a roller charging system using a roller. Alternatively, the charger 2 may employ a wire discharge system using a wire.

The exposure device 3 serves as an electrostatic latent image forming device. The exposure device 3 exposes the surface of the photoconductive drum 1 according to image data, forming an electrostatic latent image thereon. The exposure device 3 includes a laser beam scanner using a laser diode, a light-emitting diode (LED), or the like that exposes the surface of the photoconductive drum 1.

As the high voltage power supply supplies a predetermined developing bias to the developing device 4, the developing device 4 visualizes the electrostatic latent image formed on the photoconductive drum 1 into a toner image. The developing device 4 contains toner.

The photoconductive drum cleaning unit 7 accommodates a photoconductive drum cleaning blade 6 that cleans the photoconductive drum 1.

The process unit 10 serves as a unit into which the photoconductive drum 1, the charger 2, the developing device 4, and the photoconductive drum cleaning unit 7 are combined.

The four process units 10 are arranged in parallel. When the image forming apparatus 100 receives a print job for forming a full color toner image on a transfer sheet P, the primary transfer rollers 5 primarily transfer black, cyan, magenta, and yellow toner images formed on the photoconductive drums 1, respectively, onto the transfer belt 15 successively such that the black, cyan, magenta, and yellow toner images are superimposed on the transfer belt 15 that contacts the photoconductive drums 1, thus forming the full color toner image on the transfer belt 15.

The transfer belt 15 is stretched taut across the transfer belt driving roller 21, the cleaning unit opposed roller 16, the primary transfer rollers 5, and the tension roller 20. The image forming apparatus 100 further includes a driving motor serving as a driver that drives and rotates the transfer belt driving roller 21 that drives and rotates the transfer belt 15. The transfer belt driving roller 21 also serves as a secondary transfer roller opposed roller that is disposed opposite the secondary transfer roller 25.

The transfer belt 15 according to the embodiment is one example of an intermediate transferor that rotates while contacting the photoconductive drums 1 serving as image bearers.

The process units 10 and the transfer belt driving roller 21 may be driven by separate drivers, respectively, or a shared driver. However, driving of at least the process unit 10 that forms a black toner image and the transfer belt driving roller 21 is generally turned on and off simultaneously. Hence, the shared driver is preferably employed to downsize the image forming apparatus 100 and reduce costs. The image forming apparatus 100 further includes springs that bias both lateral ends of the tension roller 20 in an axial direction thereof. Thus, the tension roller 20 serves as a transfer belt stretching mechanism that stretches the transfer belt 15.

The transfer belt cleaning unit 32 includes the cleaning blade 31 that contacts counter to the transfer belt 15 that rotates counterclockwise in FIG. 1A in a rotation direction D15. The cleaning blade 31 scrapes residual toner failed to be transferred onto the transfer belt 15 and therefore remaining on the transfer belt 15 therefrom, thus cleaning the transfer belt 15. The transfer belt cleaning unit 32 according to the embodiment employs a blade system using the cleaning blade 31 as a cleaning system that cleans the transfer belt 15. Alternatively, the transfer belt cleaning unit 32 may employ an electrostatic brush system using an electrostatic cleaning brush, an electrostatic roller system using an electrostatic cleaning roller, or the like. In order to downsize the image forming apparatus 100, reduce costs, and improve cleaning, the transfer belt cleaning unit 32 preferably employs the blade system. For example, in a case that the image forming apparatus 100 employs the electrostatic brush system or the electrostatic roller system, the image forming apparatus 100 is installed with the electrostatic cleaning brush or the electrostatic cleaning roller that is applied with a bias, instead of the cleaning blade 31. However, residual toner failed to be transferred onto the transfer sheet P and therefore remaining on the transfer belt 15 may be charged preliminarily according to usage of the image forming apparatus 100, causing disadvantages such as upsizing of the transfer belt cleaning unit 32, addition of one or two systems of the high voltage power supply, and addition of extra processes for eliminating a bias.

The residual toner scraped by the cleaning blade 31 is conveyed into the waste toner container 33 through a waste toner conveyance path.

Each of the primary transfer rollers 5 is a metal roller or a conductive sponge roller. The primary transfer rollers 5 are disposed opposite the photoconductive drums 1, respectively, via the transfer belt 15. As the single high voltage power supply supplies a predetermined primary transfer bias to the primary transfer rollers 5, the primary transfer rollers 5 primarily transfer the black, cyan, magenta, and yellow toner images formed on the photoconductive drums 1, respectively, onto the transfer belt 15. Each of the primary transfer rollers 5 is a metal roller made of aluminum or stainless used steel (SUS), an ion conductive roller made of a mixture of urethane and dispersed carbon, acrylonitrile-butadiene rubber (NBR), or epichlorohydrin rubber, an electronically conductive roller made of ethylene-propylene-diene monomer (EPDM), or the like.

The transfer belt 15 is an endless belt that has a resin film shape and is made of a material produced by dispersing a conductive material such as carbon black in polyvinylidene fluoride (PVDF), ethylenetetrafluoroethylene (ETFE), polyimide (PI), polycarbonate (PC), thermoplastic elastomer (TPE), or the like.

The image forming apparatus 100 further includes a secondary transfer unit constructed of a roller or a belt. In a case that the secondary transfer unit is constructed of the roller as illustrated in FIG. 1A, the secondary transfer roller 25 is a sponge roller, that is, the ion conductive roller made of the mixture of urethane and dispersed carbon, NBR, or epichlorohydrin rubber, the electronically conductive roller made of EPDM, or the like.

The secondary transfer roller cleaning unit 27 includes the cleaning blade 26 that contacts counter to the secondary transfer roller 25 that rotates clockwise in FIG. 1B in a rotation direction D25. The cleaning blade 26 scrapes residual toner from the secondary transfer roller 25, cleaning the secondary transfer roller 25.

In a case that the secondary transfer unit is constructed of the belt as illustrated in FIG. 1B, the secondary transfer belt 28 is stretched taut across the secondary transfer roller 25 and the tension roller 29. The image forming apparatus 100 further includes a driving motor that drives and rotates the secondary transfer roller 25 that is applied with a bias. The secondary transfer roller 25 drives and rotates the secondary transfer belt 28.

The transfer sheet tray 22 or the bypass slot 42 is placed with a plurality of transfer sheets P serving as recording media. The feed roller 23 feeds a transfer sheet P to the registration roller pair 24 that conveys the transfer sheet P to a secondary transfer nip formed between the secondary transfer roller 25 and the transfer belt 15 at a time when a leading end of the full color toner image formed of the black, cyan, magenta, and yellow toner images superimposed on a surface of the transfer belt 15 reaches the secondary transfer nip. As the high voltage power supply applies a predetermined secondary transfer bias to the secondary transfer roller 25, the secondary transfer roller 25 secondarily transfers the full color toner image formed on the transfer belt 15 onto the transfer sheet P. According to the embodiment, the transfer sheet P is conveyed through a vertical conveyance path. The transfer belt driving roller 21 separates the transfer sheet P from the transfer belt 15 with a curvature of the transfer belt driving roller 21. The fixing device 40 fixes the full color toner image on the transfer sheet P. Thereafter, the transfer sheet P bearing the fixed full color toner image is ejected onto an outside of the image forming apparatus 100 through the discharge slot 41.

The fixing device 40 according to the embodiment includes a fixing rotator 40a, an opposed rotator 40b, and a heater 40c serving as a heat source. The opposed rotator 40b is disposed opposite the fixing rotator 40a. The heater 40c heats the fixing rotator 40a. As illustrated in FIGS. 1A and 1, the heater 40c is disposed outside the fixing rotator 40a. Alternatively, the heater 40c as a laminated heater may be disposed inside the fixing rotator 40a.

As illustrated in FIG. 1B, the fixing device 40 further includes a nip formation pad 40d that is disposed inside the fixing rotator 40a. The fixing rotator 40a and the opposed rotator 40b form a fixing nip 40e therebetween. The fixing rotator 40a and the opposed rotator 40b fix the unfixed full color toner image on the transfer sheet P while the fixing rotator 40a that rotates in a rotation direction D40a and the opposed rotator 40b that rotates in a rotation direction D40b convey the transfer sheet P through the fixing nip 40e.

The image forming apparatus 100 employs one of two methods, that is, an attraction transfer method and a repulsion transfer method. The attraction transfer method generates a secondary transfer electric field by applying a positive bias as a secondary transfer bias to the secondary transfer roller 25 and grounding the transfer belt driving roller 21. The repulsion transfer method generates a secondary transfer electric field by applying a negative bias as a secondary transfer bias to the transfer belt driving roller 21 and grounding the secondary transfer roller 25.

A description is provided of a construction of an image forming system 1000 that incorporates the image forming apparatus 100 depicted in FIG. 1A.

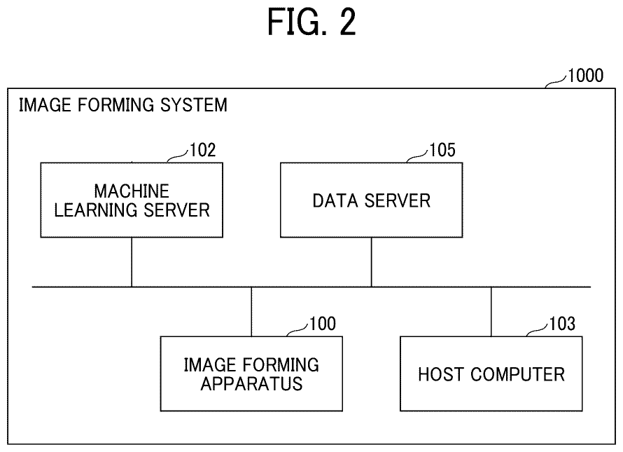

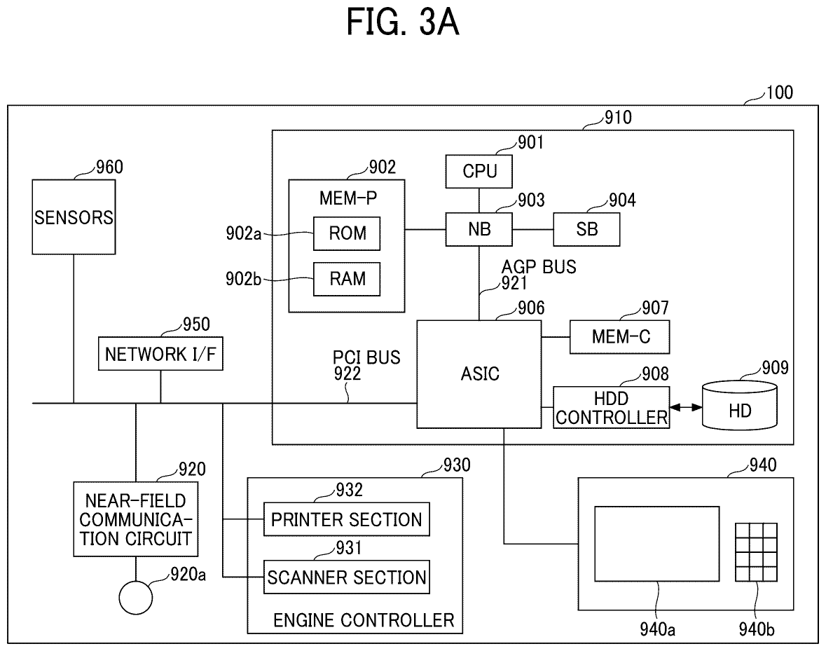

FIG. 2 is a block diagram of the image forming system 1000, illustrating a system configuration thereof as one example.

The image forming system 1000 according to the embodiment includes the image forming apparatus 100, a machine learning server 102, a host computer 103 (e.g., a mainframe), and a data server 105. The image forming apparatus 100 incorporates components (e.g., devices) that are connected via a network such as a local area network (LAN). The network that connects the components is wired or wireless. The machine learning server 102 and the data server 105 may be connected to the image forming apparatus 100 via the Internet or the like to communicate with the image forming apparatus 100.

The image forming apparatus 100 is a copier, a printer, a multifunctional peripheral (MFP), a facsimile machine, or the like. The image forming apparatus 100 is installed with an artificial intelligence (AI) capability that estimates a life of the transfer belt 15.

The machine learning server 102 generates a learned model to achieve the AI capability installed in the image forming apparatus 100.

The host computer 103 sends print data to the image forming apparatus 100. The data server 105 collects learning data used to perform machine learning in the machine learning server 102 from an external device such as the image forming apparatus 100 and sends the learning data to the machine learning server 102. The learning data includes various data that indicate a condition of the image forming apparatus 100. The learning data is described below in detail.

In the image forming system 1000, the image forming apparatus 100 receives the learned model generated by the machine learning server 102 from the machine learning server 102 and achieves a particular AI capability by using the learned model. In the image forming system 1000, the machine learning server 102 receives the learning data used to learn the learned model to achieve the particular AI capability from the external device such as the data server 105, the image forming apparatus 100, and the host computer 103. The machine learning server 102 uses a part or an entirety of the learning data to perform learning processes, generating the learned model.

According to the embodiment, the image forming apparatus 100 uses the learned model generated by using the learning data including information indicating the condition of the image forming apparatus 100. Thus, in a case that the image forming apparatus 100 detects an abnormality, the image forming apparatus 100 determines a type of the abnormality. If the abnormality results from the image forming apparatus 100, the image forming apparatus 100 interrupts operation. If the abnormality results from a usage of a user of the image forming apparatus 100, the image forming apparatus 100 performs control according to the usage of the user. According to the embodiment, the abnormality encompasses a failure and an error.

According to the embodiment, the image forming apparatus 100 operates as described above, addressing the abnormality to be overcome instantly and suppressing redundant downtime.

The machine learning server 102 and the data server 105 according to the embodiment may be constructed by an identical computer. The image forming apparatus 100 may perform functions similar to functions performed by the machine learning server 102 and the data server 105. The machine learning server 102 and the data server 105 may be constructed by a single computer or a plurality of computers. For example, the machine learning server 102 and the data server 105 may be constructed with a technology of cloud computing.

A description is provided of a hardware configuration of the image forming apparatus 100 and the machine learning server 102.

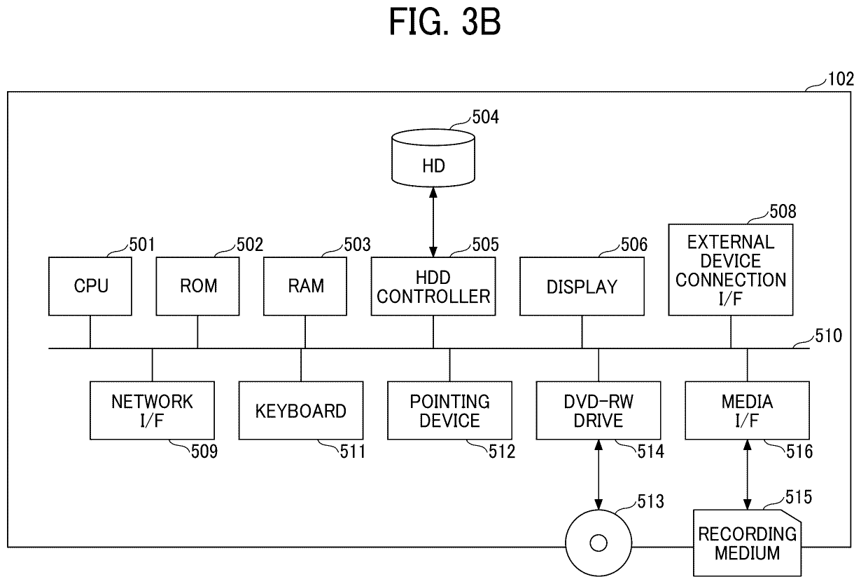

FIG. 3A is a block diagram of the image forming apparatus 100, illustrating the hardware configuration thereof as one example.

As illustrated in FIG. 3A, the image forming apparatus 100 includes a controller 910, a near-field communication circuit 920, an engine controller 930, a control panel 940, a network interface (I/F) 950, and sensors 960.

The controller 910 includes a central processing unit (CPU) 901 as a main section of a computer, a system memory (MEM-P) 902, a northbridge (NB) 903, a southbridge (SB) 904, an application specific integrated circuit (ASIC) 906, a local memory (MEM-C) 907 as a storage, a hard disk drive (HDD) controller 908, and a hard disk (HD) 909 as a storage. The controller 910 further includes an accelerated graphics port (AGP) bus 921 through which the NB 903 is connected to the ASIC 906.

The CPU 901 is a controller that controls an entirety of the image forming apparatus 100. The NB 903 connects the CPU 901, the MEM-P 902, the SB 904, and the AGP bus 921. The NB 903 includes a memory controller that controls reading, writing, and the like with respect to the MEM-P 902, a peripheral component interconnect (PCI) master, and an AGP target.

The MEM-P 902 includes a read only memory (ROM) 902a and a random access memory (RAM) 902b. The ROM 902a is a memory that stores programs and data that perform functions of the controller 910. The RAM 902b is a memory or the like used for expansion of the programs and the data and drawing for printing. The programs stored in the RAM 902b may be recorded in a recording medium readable by a computer, such as a compact disc read-only memory (CD-ROM), a compact disc-recordable (CD-R), and a digital versatile disc (DVD), in a file format installable or executable.

The SB 904 is a bridge that connects the NB 903 to a PCI device and a peripheral device. The ASIC 906 is an integrated circuit (IC) that is used for image processing and includes a hardware element for image processing. The ASIC 906 serves as a bridge that connects the AGP bus 921, a PCI bus 922, the HDD controller 908, and the MEM-C 907 to each other. The ASIC 906 includes a PCI target, an AGP master, an arbiter (ARB), a memory controller, a plurality of direct memory access controllers (DMAC), and a PCI unit. The ARB is a core of the ASIC 906. The memory controller controls the MEM-C 907. The DMAC performs rotation and the like of image data with hardware logic and the like. The engine controller 930 includes a scanner section 931 and a printer section 932. The PCI unit transfers data between the scanner section 931 and the printer section 932 through the PCI bus 922. The ASIC 906 is connected to an interface based on the universal serial bus (USB) or an interface based on the institute of electrical and electronics engineers (IEEE) 1394.

The MEM-C 907 is a local memory used as an image buffer for printing and an encoding buffer. The HD 909 is a storage that stores image data, font data used for printing, and forms. The HD 909 controls reading or writing of data with respect to the HD 909 under control of the CPU 901. The AGP bus 921 is a bus interface for a graphics accelerator card proposed to accelerate graphics processing. The AGP bus 921 accesses the MEM-P 902 directly at a high throughput, accelerating the graphics accelerator card.

The near-field communication circuit 920 is coupled with an antenna 920a. The near-field communication circuit 920 is a communication circuit using near-field communication (NFC), Bluetooth®, or the like.

The engine controller 930 includes the printer section 932. The engine controller 930 further includes the scanner section 931. The control panel 940 includes a display 940a and a keyboard 940b. The display 940a includes a touch panel that displays current settings, a selection screen, and the like and receives instructions from the user. The keyboard 940b includes number keys and a start key. The number keys receive a value of a setting condition relating to image formation such as a setting condition of a density of a toner image. The start key receives an instruction to start copying. The controller 910 controls the entirety of the image forming apparatus 100. For example, the controller 910 controls drawing, communication, input from the control panel 940, and the like. The printer section 932 or the scanner section 931 includes an image processor that performs error diffusion, gamma conversion, and the like. The control panel 940 is one example of a display device of the image forming apparatus 100.

The control panel 940 displays application switch keys used to switch between a plurality of functions such as a printer function, settings, color adjustment, and scheduling of printing and maintenance. The application switch keys are also used to switch selectively between a document server function, a copy function, a facsimile function, and the like successively. The network I/F 950 is an interface for data communications using a communication network. The near-field communication circuit 920 and the network I/F 950 are electrically connected to the ASIC 906 through the PCI bus 922.

The sensors 960 include various sensors that detect conditions of the image forming apparatus 100, respectively. In other words, the sensors 960 output sensor values used to detect an abnormality of the image forming apparatus 100 serving as the electronic apparatus.

For example, the sensors 960 include a sensor that detects a voltage of a primary transfer bias, a sensor that detects a density of toner on density adjustment patterns formed on the transfer belt 15, and a sensor that detects an interval between the density adjustment patterns. The sensors 960 further include a sensor that detects torque of the transfer belt driving roller 21 that drives and rotates the transfer belt 15. The torque of the transfer belt driving roller 21 is defined by a driving electric current of the driving motor that drives and rotates the transfer belt driving roller 21. The sensors 960 further include a sensor that detects a temperature and a humidity of a space in which the image forming apparatus 100 is located and a sensor that detects a temperature and a humidity of an interior of the image forming apparatus 100. The sensors 960 further include a sensor that detects an operating time (e.g., a rotation time) of the transfer belt driving roller 21 and a sensor that detects a fixing temperature of the fixing device 40.

FIG. 3B is a block diagram of the machine learning server 102, illustrating a hardware configuration thereof as one example. The machine learning server 102 according to the embodiment is constructed by a computer. The machine learning server 102 includes a CPU 501, a ROM 502, a RAM 503, an HD 504, an HDD controller 505, a display 506, an external device connection I/F 508, a network I/F 509, a data bus 510, a keyboard 511, a pointing device 512, a digital versatile disc rewritable (DVD-RW) drive 514, and a media I/F 516.

The CPU 501 controls operation of an entirety of the machine learning server 102. The ROM 502 stores a program used to drive the CPU 501, such as an initial program loader (IPL). The RAM 503 is used as a work area of the CPU 501. The HD 504 stores various data such as programs. The HDD controller 505 controls reading or writing of various data with respect to the HD 504 under control of the CPU 501. The display 506 displays various information such as a cursor, a menu, a window, a character, and an image. The external device connection I/F 508 is an interface coupled with various external devices. For example, the external devices include a USB memory and a printer. The network I/F is an interface used to perform data communications using a communication network. The data bus 510 includes an address bus and a data bus that electrically connect elements such as the CPU 501 depicted in FIG. 3B.

The keyboard 511 is one example of an input device that includes a plurality of keys used to input characters, values, instructions, and the like. The pointing device 512 is one example of an input device used to select and execute the instructions, select a target for processing, and move the cursor. The DVD-RW drive 514 controls reading or writing of various data with respect to a DVD-RW 513 as one example of a recording medium that is removably inserted into the DVD-RW drive 514. Alternatively, instead of the DVD-RW 513, a digital versatile disc recordable (DVD-R) or the like may be used. The media I/F 516 controls reading or writing (e.g., storing) of data with respect to a recording medium 515 such as a flash memory.

Each of the host computer 103 and the data server 105 according to the embodiment has a hardware configuration similar to the hardware configuration of the machine learning server 102. Hence, a description of the hardware configuration of each of the host computer 103 and the data server 105 is omitted.

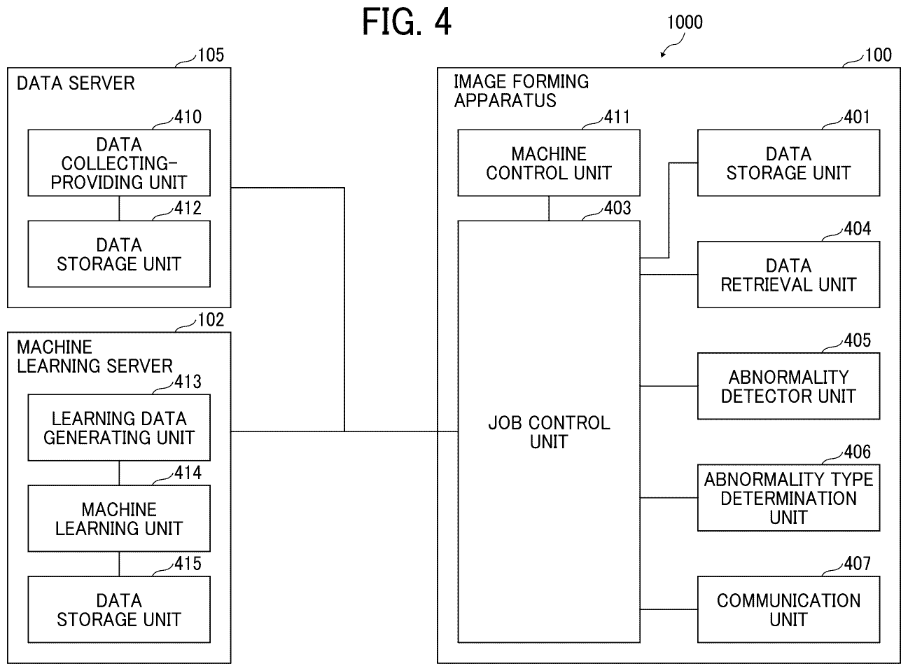

Referring to FIG. 4, a description is provided of a functional configuration of elements of the image forming system 1000.

FIG. 4 is a block diagram of the image forming system 1000, illustrating the functional configuration of the elements thereof.

FIG. 4 illustrates functional units that are established by using hardware resources depicted in FIGS. 3A and 3B and programs, for example. The programs that establish the functional units depicted in FIG. 4 are stored in storages of the elements of the image forming system 1000, respectively. Each of the elements includes a RAM (e.g., the RAMs 902b and 503) that reads the program and a CPU (e.g., the CPUs 901 and 501) that executes the program.

For example, in the image forming apparatus 100 depicted in FIG. 3A, the HD 909 stores the program. The RAM 902b reads the program. The CPU 901 executes the program. In the machine learning server 102 depicted in FIG. 3B, the HD 504 stores the program. The RAM 503 reads the program. The CPU 501 executes the program. Similarly, the data server 105 depicted in FIG. 2 includes an HD that stores the program, a RAM that reads the program, and a CPU that executes the program.

In the image forming system 1000 according to the embodiment depicted in FIG. 4, each of the functional units of the image forming system 1000 performs machine learning of a dataset that correlates time series data to a type of an abnormality that occurs in the image forming apparatus 100. The time series data defines sensor values collected from the sensors 960 of the image forming apparatus 100 over time. If the image forming apparatus 100 detects an abnormality, the image forming apparatus 100 determines the type of the abnormality. The image forming apparatus 100 performs control according to the type of the abnormality. Thus, the image forming apparatus 100 according to the embodiment addresses the abnormality instantly and suppresses redundant downtime.

A description is provided of the functional units of the image forming apparatus 100.

The image forming apparatus 100 according to the embodiment includes a data storage unit 401, a job control unit 403, a machine control unit 411, a data retrieval unit 404, an abnormality detector unit 405, an abnormality type determination unit 406, and a communication unit 407.

The data storage unit 401 stores data input to and output from the image forming apparatus 100, such as image data, learning data described below, and a learned model, with respect to the RAM 902b and the HD 909 in the hardware configuration depicted in FIG. 3A.

The data storage unit 401 further stores time series data retrieved by the data retrieval unit 404 and information relating to a service engineer to whom maintenance of the image forming apparatus 100 is requested.

When the job control unit 403 receives a job based on an instruction from the user, the job control unit 403 implements a basic function of the image forming apparatus 100, such as copying, facsimile, and printing, according to the job. As the job control unit 403 implements the basic function, the job control unit 403 sends and receives an instruction and data to and from other functional unit.

The machine control unit 411 performs control according to a determination result sent from the abnormality type determination unit 406. For example, the machine control unit 411 interrupts operation of the image forming apparatus 100. The machine control unit 411 sends a notice that requests maintenance of the image forming apparatus 100 to the service engineer who performs maintenance.

The machine control unit 411 performs control according to a usage of the image forming apparatus 100. For example, the machine control unit 411 switches between a plurality of transfer sheet trays 22 automatically. The machine control unit 411 converts color image data into monochrome image data. In a case that a voltage available in an environment where the image forming apparatus 100 is located is not greater than a voltage specified by a product specification, the machine control unit 411 delays a feed start time at which the feed roller 23 starts feeding a transfer sheet P, stores heat in the charger 2 sufficiently, and continues printing. In a case that the machine control unit 411 detects an abnormality of a sensor that measures a value not affecting control of the heater 40c directly, the machine control unit 411 decreases productivity of the image forming apparatus 100 to continue printing safely.

The data retrieval unit 404 retrieves time series data obtained by collecting sensor values output from various sensors of the sensors 960 over time. According to the embodiment, data obtained by collecting the sensor values output from various sensors of the sensors 960 over time define the time series data.

The abnormality detector unit 405 detects an abnormality of the image forming apparatus 100 based on the time series data retrieved by the data retrieval unit 404. For example, in a case that the time series data satisfies a predetermined rule that is determined in advance, the abnormality detector unit 405 detects the abnormality of the image forming apparatus 100. The abnormality detector unit 405 stores the predetermined rule in advance. For example, the predetermined rule has a definition that a sensor value output from a particular sensor of the sensors 960 is not smaller than a threshold.

The abnormality detector unit 405 detects an abnormality of the fixing device 40 of the image forming apparatus 100 based on the time series data retrieved by the data retrieval unit 404. For example, the abnormality detector unit 405 detects an abnormality (e.g., a failure) of the sensor 960 that detects the temperature of the fixing rotator 40a of the fixing device 40.

The abnormality type determination unit 406 stores the learned model learned by the machine learning server 102 described below. As the abnormality detector unit 405 detects the abnormality, the abnormality type determination unit 406 inputs the time series data retrieved in a predetermined time period encompassing a time when the abnormality is detected to the learned model and obtains information indicating a type of the abnormality from the learned model. The abnormality type determination unit 406 sends the information indicating the type of the abnormality to the machine control unit 411.

The communication unit 407 performs communication between the image forming apparatus 100 and other devices. For example, the communication unit 407 sends the time series data to the data server 105.

A description is provided of the functional units of the data server 105.

The data server 105 includes a data collecting-providing unit 410 and a data storage unit 412 as software.

The data collecting-providing unit 410 collects and provides learning data to be learned by the machine learning server 102. For example, the data collecting-providing unit 410 collects the time series data retrieved by the data retrieval unit 404 from the image forming apparatus 100 and stores the time series data into the data storage unit 412. The data collecting-providing unit 410 sends the time series data stored in the data storage unit 412 to the machine learning server 102.

A description is provided of the functional units of the machine learning server 102.

The machine learning server 102 includes a learning data generating unit 413, a machine learning unit 414, and a data storage unit 415.

The learning data generating unit 413 generates a dataset (e.g., learning data) that correlates the time series data received from the data server 105 to the information indicating the type of the abnormality of the image forming apparatus 100 when the time series data is retrieved.

According to the embodiment, the information indicating the type of the abnormality, that correlates to the time series data, may be obtained with the time series data from the image forming apparatus 100. Alternatively, an administrator of the image forming apparatus 100 may input the information indicating the type of the abnormality to the data server 105 and the machine learning server 102 and the information indicating the type of the abnormality may correlate to the time series data.

In order to obtain a target learning effect from the time series data, the learning data generating unit 413 deletes unnecessary data that may cause noise. In order to input the time series data to the learned model generated by the machine learning unit 414, the learning data generating unit 413 adjusts a format of the learning data, optimizing the learning data.

The machine learning unit 414 defines the learning data generated by the learning data generating unit 413 as an input and performs machine learning by using a learning method with the learning model described below effectively.

The data storage unit 415 temporarily stores the time series data received from the data server 105, the learning data generated by the learning data generating unit 413, and the learned model generated by the machine learning unit 414.

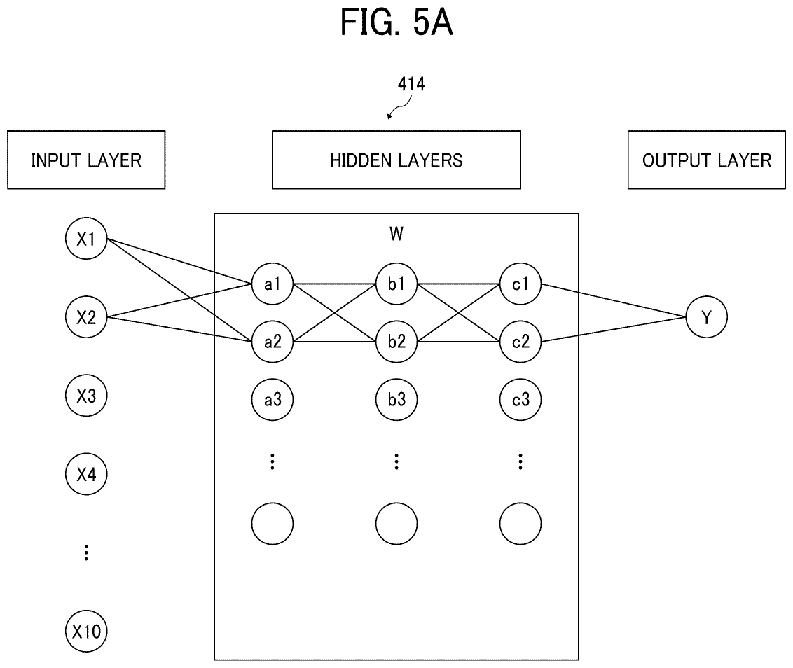

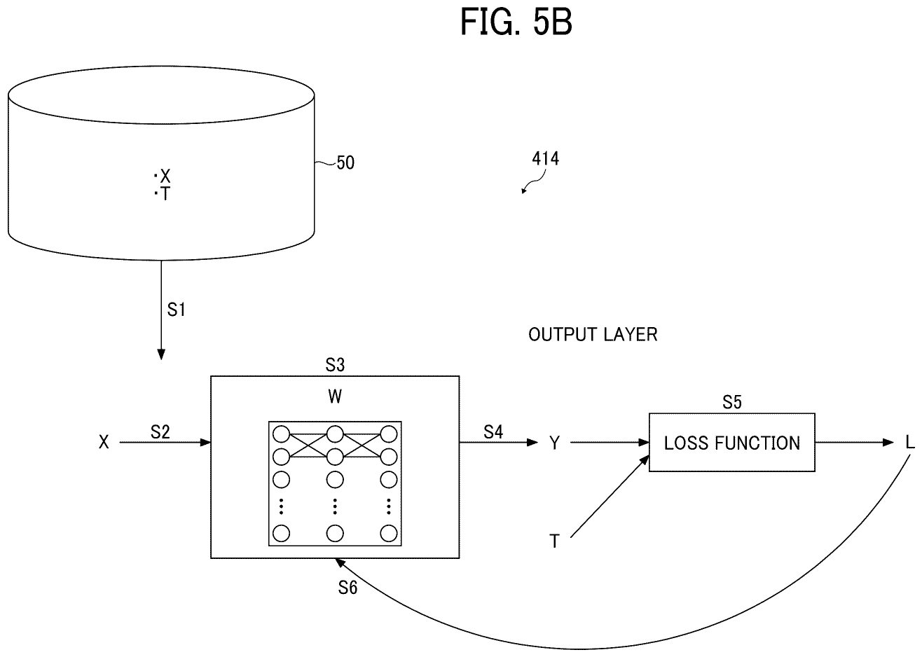

Referring to FIGS. 5A and 5B, a description is provided of a configuration of the machine learning unit 414 according to the embodiment.

FIG. 5A is a first illustration of the machine learning unit 414, illustrating an input-output configuration thereof using the learning model as one example. FIG. 5B is a second illustration of the machine learning unit 414, illustrating the input-output configuration thereof using the learning model as one example. FIGS. 5A and 5B illustrate the learning model using a neural network.

As one example for describing features of the image forming system 1000 according to the embodiment, the learning data includes elements X1 to X10 that are involved in generation of the learning model that predicts the type of the abnormality as an output based on the time series data as an input by using the neural network.

The elements X1 to X10 of the learning data define factors that relate to the type of the abnormality of the image forming apparatus 100. For example, the factors include an environment, a usage time of the transfer belt driving roller 21, a fixing temperature of the fixing device 40, and an electric current of the driving motor. However, the factors are not limited to the above.

According to the embodiment, pieces of information included in the time series data obtained from the image forming apparatus 100 define the elements X1 to X10 of the learning data, respectively. The elements X1 to X10 of the learning data according to the embodiment are described below in detail.

The elements X1 to X10 of the learning data are not limited to the information included in the time series data and may include other information.

For example, in addition to the neural network, machine learning uses algorithm including nearest neighbor algorithm, Naïve Bayes algorithm, decision tree algorithm, support vector machine algorithm, and the like. Further, machine learning uses deep learning that generates for itself a feature value to be learned and a binding weighting coefficient by using the neural network. The above-described algorithms are selectively used and applied to the embodiment of the present disclosure.

The learning model includes an error detector unit and an update unit.

Referring to FIG. 5B, a description is provided of the learning model.

The error detector unit of the learning model obtains an error between an output data Y and a training data T to calculate a loss L representing the error by using a loss function. The output data Y is calculated by using the neural network based on an input data X input to an input layer depicted in FIG. 5A and is output from an output layer depicted in FIG. 5B. As illustrated in FIG. 5A, three hidden layers (e.g., intermediate layers) lie between the input layer and the output layer. The three hidden layers are a first hidden layer including nodes a1, a2, a3, and more, a second hidden layer including nodes b1, b2, b3, and more, and a third hidden layer including nodes c1, c2, c3, and more.

The update unit updates the binding weighting coefficient and the like between nodes of the neural network based on the loss L obtained by the error detector unit such that the loss L decreases, for example, such that the loss L is closer to zero. For example, the update unit uses backpropagation algorithm to update the binding weighting coefficient and the like between the nodes of the neural network. The backpropagation algorithm adjusts the binding weighting coefficient and the like between the nodes of each of the neural networks so that the error decreases.

Referring to FIG. 5B, a description is provided of learning processes.

The learning data generating unit 413 of the machine learning server 102 according to the embodiment provides numerous learning data 50 in a process S1. The learning data 50 combines the input data X and the training data T as a set. The input data X has a known actual value (e.g., training data).

Subsequently, the machine learning unit 414 inputs the input data X corresponding to the training data T to a learning model W in a process S2. The machine learning unit 414 calculates with the learning model W in a process S3. The machine learning unit 414 obtains the output data Y in a process S4. Subsequently, the machine learning unit 414 obtains the error between the output data Y and the training data T and calculates the loss L representing the error by using the loss function in a process S5. Subsequently, the machine learning unit 414 updates the binding weighting coefficient and the like between the nodes of the neural network based on the loss L so that the loss L decreases in a process S6.

According to the embodiment, the machine learning unit 414 adjusts the binding weighting coefficient between the nodes of the neural network as described above, obtaining the learning model W with an enhanced accuracy. According to the embodiment described below, the processes S1 to S6 define learning processes. The learning model adjusted through the learning processes defines the learned model.

The learning data 50 according to the embodiment defines data as a set of the input data X and the training data T (e.g., a failure of the sensor 960). The input data X is the time series data in a case that a speed at which the temperature of the fixing rotator 40a increases is lower than a predetermined threshold.

According to the embodiment, the machine learning unit 414 that uses the learning data 50 causes the learning model W to learn a relation between the time series data and the type of the abnormality of the image forming apparatus 100 by machine learning. In other words, the machine learning unit 414 according to the embodiment generates the learned model that defines the time series data of the image forming apparatus 100 as the input and the information indicating the type of the abnormality of the image forming apparatus 100 as the output.

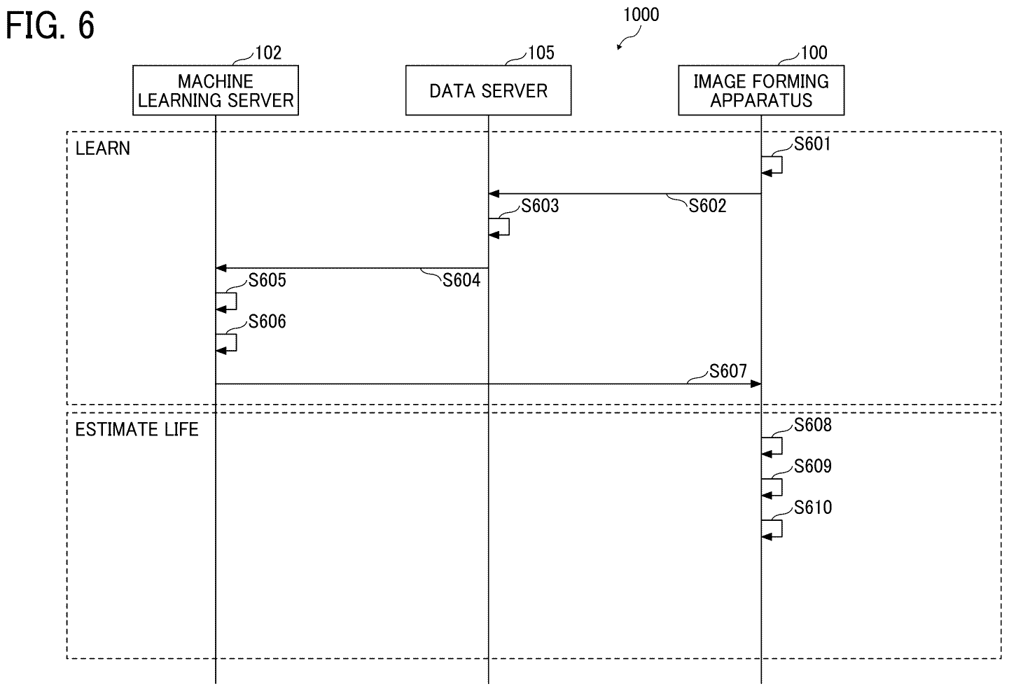

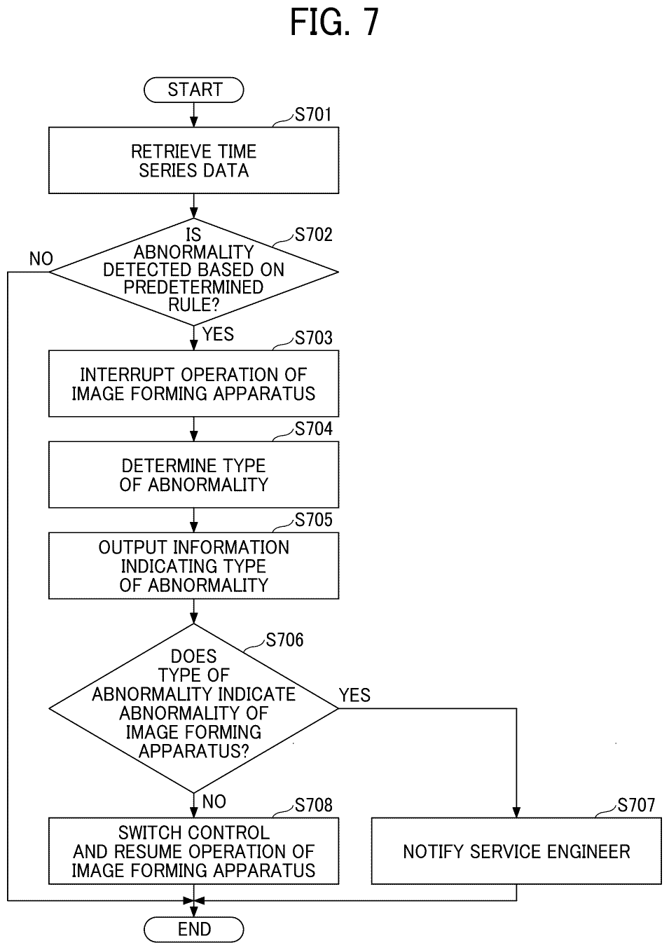

Referring to FIG. 6, a description is provided of operation of the image forming system 1000 according to the embodiment.

FIG. 6 is a sequential diagram of the image forming system 1000, illustrating operation thereof.

FIG. 6 illustrates steps S601 to S607 representing processes for generating the learned model. FIG. 6 further illustrates steps S608 to S610 representing processes for detecting the abnormality of the image forming apparatus 100. The processes for generating the learned model and the processes for detecting the abnormality of the image forming apparatus 100 may be performed at separate times as separate processes, respectively.

A description is provided of the processes for generating the learned model.

In step S601, the data retrieval unit 404 of the image forming apparatus 100 according to the embodiment retrieves time series data obtained by collecting sensor values output from the sensors 960 of the image forming apparatus 100 over time. In step S602, the data retrieval unit 404 sends the time series data to the data server 105.

In step S603, the data collecting-providing unit 410 of the data server 105 receives the time series data and the data storage unit 412 of the data server 105 stores the time series data.

In step S604, the data collecting-providing unit 410 of the data server 105 sends the time series data received from the image forming apparatus 100 to the machine learning server 102. If the data storage unit 412 of the data server 105 stores condition information about the condition of the image forming apparatus 100 in an amount not smaller than a predetermined amount, the data server 105 sends the condition information to the machine learning server 102.

In step S605, when the machine learning server 102 receives the time series data, the learning data generating unit 413 generates the learning data. For example, the learning data generated by the learning data generating unit 413 according to the embodiment includes the time series data obtained in a predetermined time period including a time when an abnormality (e.g., a failure) of one or more sensors of the sensors 960 is detected and the time series data obtained in a predetermined time period including a time when an abnormality (e.g., a failure) of other element of the image forming apparatus 100 is detected.

Subsequently, in step S606, the machine learning server 102 performs machine learning by using the learning data generated by the learning data generating unit 413, generating the learned model. In step S607, the machine learning server 102 sends the learned model that is generated to the image forming apparatus 100.

The above describes the processes for generating the learned model. The abnormality type determination unit 406 stores the learned model sent to the image forming apparatus 100.

A description is provided of the processes for detecting the abnormality.

In step S608, the data retrieval unit 404 of the image forming apparatus 100 obtains the time series data of the image forming apparatus 100.

Subsequently, in step S609, the abnormality detector unit 405 of the image forming apparatus 100 detects an abnormality of the image forming apparatus 100. In step S610, the machine control unit 411 of the image forming apparatus 100 performs control according to a detection result of detection of the abnormality.

Referring to FIG. 7, a description is provided of processes in steps S609 and S610 in detail.

FIG. 7 is a flowchart of the processes performed by the image forming apparatus 100. The image forming apparatus 100 according to the embodiment performs the processes depicted in FIG. 7 periodically.

In step S701, the data retrieval unit 404 of the image forming apparatus 100 retrieves the time series data. Subsequently, in step S702, the abnormality detector unit 405 of the image forming apparatus 100 determines whether or not the condition of the image forming apparatus 100 is faulty based on the time series data retrieved in step S701 and the predetermined rule.

In a case that the abnormality detector unit 405 determines that the condition of the image forming apparatus 100 is normal in step S702, that is, in a case that the abnormality detector unit 405 does not detect an abnormality of the image forming apparatus 100 (NO in step S702), the image forming apparatus 100 finishes the processes.

In a case that the abnormality detector unit 405 detects an abnormality of the image forming apparatus 100 based on the predetermined rule (YES in step S702), the machine control unit 411 of the image forming apparatus 100 interrupts operation of the image forming apparatus 100 in step S703.

Subsequently, in step S704, the abnormality type determination unit 406 of the image forming apparatus 100 determines the type of the abnormality. For example, the image forming apparatus 100 inputs the time series data retrieved by the data retrieval unit 404 in step S701 to the learned model stored in the abnormality type determination unit 406, obtaining information indicating the type of the abnormality output by the learned model.

Subsequently, in step S705, the abnormality type determination unit 406 outputs the information indicating the type of the abnormality to the machine control unit 411.

In step S706, the machine control unit 411 determines whether or not the type of the abnormality detected in step S702 indicates an abnormality of the image forming apparatus 100 based on the information indicating the type of the abnormality.

The machine control unit 411 according to the embodiment stores an abnormality type table listing abnormalities of the image forming apparatus 100 in advance. The machine control unit 411 compares the information indicating the type of the abnormality output by the abnormality type determination unit 406 with the abnormality type table to determine whether or not the abnormality detected in step S702 is the abnormality of the image forming apparatus 100.

In a case that the machine control unit 411 determines that the type of the abnormality detected in step S702 is the abnormality of the image forming apparatus 100 (YES in step S706), the machine control unit 411 notifies the service engineer that maintenance of the image forming apparatus 100 is necessary in step S707 and finishes the processes. The image forming apparatus 100 continues interrupting operation.

In a case that the machine control unit 411 determines that the type of the abnormality detected in step S702 is not the abnormality of the image forming apparatus 100 (NO in step S706), that is, in a case that the abnormality of the image forming apparatus 100 results from a usage of the image forming apparatus 100, the machine control unit 411 switches to a control that fits the usage of the image forming apparatus 100 and resumes operation of the image forming apparatus 100 in step S708.

As described above, the image forming apparatus 100 according to the embodiment detects the abnormality thereof based on the predetermined rule. In a case that the image forming apparatus 100 detects the abnormality, the image forming apparatus 100 interrupts operation. Thereafter, the image forming apparatus 100 determines the type of the abnormality by using the learned model. In a case that the type of the abnormality does not request instant interruption of operation of the image forming apparatus 100, the image forming apparatus 100 resumes operation.

Accordingly, the image forming apparatus 100 according to the embodiment addresses the abnormality to be overcome instantly and suppresses redundant downtime.

As described above, the image forming system 1000 according to the embodiment has a configuration in which the machine learning server 102 generates the learned model and sends the learned model to the image forming apparatus 100 so that the image forming apparatus 100 determines the type of the abnormality. Alternatively, the image forming system 1000 may have other configuration.

For example, the image forming system 1000 according to the embodiment may have a configuration in which the machine learning server 102 stores the learned model and determines the type of the abnormality. Accordingly, in a case that the abnormality detector unit 405 of the image forming apparatus 100 detects an abnormality, for example, the communication unit 407 sends the time series data retrieved by the data retrieval unit 404 to the machine learning server 102. The machine learning server 102 inputs the time series data received from the image forming apparatus 100 to the learned model. The machine learning server 102 sends the information indicating the type of the abnormality output from the learned model to the image forming apparatus 100.

According to the embodiment described above, the machine learning server 102 generates the learned model. Alternatively, other element may generate the learned model. For example, the image forming apparatus 100 may generate the learned model. In other words, the image forming apparatus 100 may have functions of the machine learning server 102 and the data server 105.

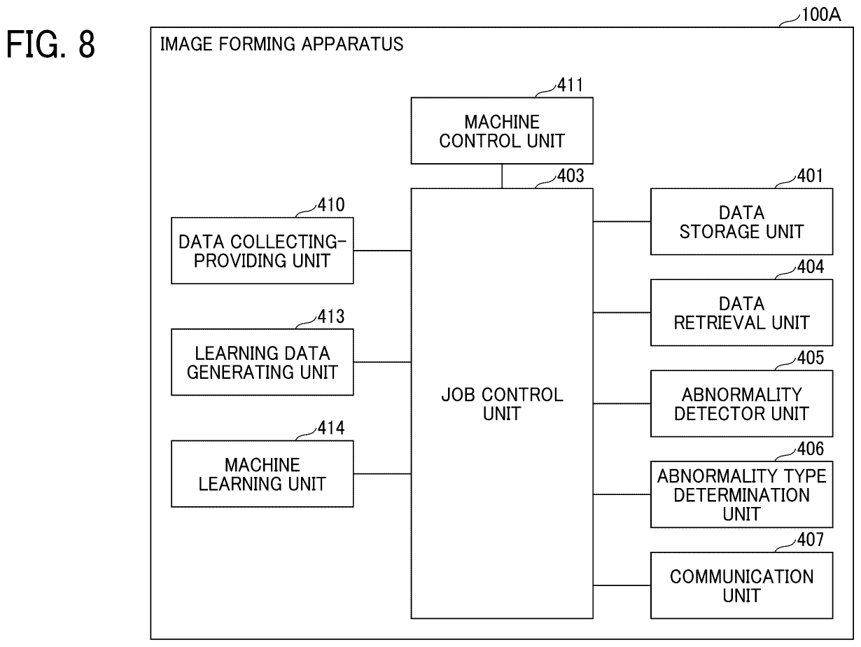

Referring to FIG. 8, a description is provided of a functional configuration of elements of an image forming apparatus 100A according to another embodiment of the present disclosure.

FIG. 8 is a block diagram of the image forming apparatus 100A, illustrating the functional configuration of the elements thereof.

In addition to the functional units of the image forming apparatus 100 depicted in FIG. 4, the image forming apparatus 100A depicted in FIG. 8 includes the learning data generating unit 413 and the machine learning unit 414 of the machine learning server 102 and the data collecting-providing unit 410 of the data server 105.

Since the image forming apparatus 100A incorporates the learning data generating unit 413 and the machine learning unit 414, the image forming apparatus 100A generates the learned model.

In a case that an image forming system includes an image forming apparatus that includes the data collecting-providing unit 410, the learning data generating unit 413, and the machine learning unit 414, like the image forming apparatus 100A, the image forming system does not include the machine learning server 102 and the host computer 103.

Each of the image forming apparatuses 100 and 100A according to the embodiments serves as one example of an electronic apparatus. However, the electronic apparatus is not limited to the image forming apparatus 100 or 100A. The technology of the present disclosure is applied to any electronic apparatus that includes a sensor for detecting a condition of the electronic apparatus and obtains a sensor value output from the sensor over time.

The functional units according to the embodiments described above are established by one or more processing circuitry. The processing circuitry according to the embodiments of the present disclosure encompasses a processor programmed to execute the functional units with software like a processor implemented by an electronic circuit. The processing circuitry further encompasses a device designed to execute the functional units described above, such as an application specific integrated circuit (ASIC), a digital signal processor (DSP), a field programmable gate array (FPGA), and a general circuit module.

The elements according to the embodiments of the present disclosure indicate one example of a plurality of computing environments that implements the embodiments of the present disclosure.

According to an embodiment of the present disclosure, the machine learning server 102 and an image forming apparatus (e.g., the image forming apparatuses 100 and 100A) include a plurality of computing devices such as a server cluster. The plurality of computing devices communicates with each other through a communication link of an arbitrary type that includes a network and a shared memory. The plurality of computing devices implements the processes described above. Similarly, the machine learning server 102 and the image forming apparatus include a plurality of computing devices that communicates with each other.

The machine learning server 102 and the image forming apparatus share the processes described above with various combinations. For example, the machine learning server 102 and the image forming apparatus implement the process implemented by a predetermined unit. Similarly, each of the machine learning server 102 and the image forming apparatus implements a function of the predetermined unit. The elements of each of the machine learning server 102 and the image forming apparatus are installed in a single server collectively or installed in a plurality of servers separately.

The image forming apparatus is any apparatus that has a communication function. For example, the image forming apparatus is a projector (PJ), an output device such as a digital signage, a head-up display (HUD), industrial machinery, an imaging device, a sound collector, a medical device, a network-connected home appliance, a connected car, a laptop personal computer, a mobile phone, a smartphone, a tablet, a video game console, a personal digital assistant (PDA), a digital camera, a wearable computer, a desktop personal computer, or the like.

A description is provided of aspects of the embodiments of the present disclosure.

A description is provided of a first aspect of the embodiments of the present disclosure.

As illustrated in FIGS. 3A, 4, and 8, an electronic apparatus (e.g., the image forming apparatuses 100 and 100A) includes a sensor (e.g., the sensors 960), a data retriever (e.g., the data retrieval unit 404), an abnormality detector (e.g., the abnormality detector unit 405), an abnormality type determiner (e.g., the abnormality type determination unit 406), and a machine controller (e.g., the machine control unit 411).

The data retriever retrieves time series data obtained by collecting sensor values output from the sensor over time. The abnormality detector detects an abnormality based on the time series data retrieved by the data retriever and a predetermined rule that is determined in advance. In a case that the abnormality detector detects the abnormality, the abnormality type determiner inputs the time series data retrieved by the data retriever to a learned model and obtains information indicating a type of the abnormality from the learned model. The learned model defines the time series data as input data and the information indicating the type of the abnormality as output data. The machine controller controls operation of the electronic apparatus based on the information indicating the type of the abnormality obtained by the abnormality type determiner.

A description is provided of a second aspect of the embodiments of the present disclosure.

According to the first aspect, in a case that the abnormality detector detects the abnormality, the machine controller interrupts operation of the electronic apparatus.

A description is provided of a third aspect of the embodiments of the present disclosure.

According to the second aspect, in a case that the machine controller determines that the information indicating the type of the abnormality obtained by the abnormality type determiner indicates an abnormality of the electronic apparatus, the machine controller interrupts operation of the electronic apparatus. In a case that the machine controller determines that the information indicating the type of the abnormality obtained by the abnormality type determiner indicates an abnormality resulting from usage of the electronic apparatus, the machine controller resumes operation of the electronic apparatus.

A description is provided of a fourth aspect of the embodiments of the present disclosure.

As illustrated in FIG. 4, an anomaly detection system (e.g., the image forming system 1000) includes an information processing device (e.g., the machine learning unit 414) and an electronic apparatus (e.g., the image forming apparatuses 100 and 100A). The electronic apparatus includes a sensor (e.g., the sensors 960), a data retriever (e.g., the data retrieval unit 404), an abnormality detector (e.g., the abnormality detector unit 405), an abnormality type determiner (e.g., the abnormality type determination unit 406), a communicator (e.g., the communication unit 407), and a machine controller (e.g., the machine control unit 411).

The data retriever retrieves time series data obtained by collecting sensor values output from the sensor over time. The abnormality detector detects an abnormality based on the time series data retrieved by the data retriever and a predetermined rule that is determined in advance. In a case that the abnormality detector detects the abnormality, the communicator sends the time series data to the information processing device. The machine controller controls operation of the electronic apparatus based on information indicating a type of the abnormality sent from the information processing device. The abnormality type determiner inputs the time series data received from the data retriever to a learned model and obtains the information indicating the type of the abnormality from the learned model. The learned model defines the time series data as input data and the information indicating the type of the abnormality as output data. The information processing device sends the information indicating the type of the abnormality to the electronic apparatus.

A description is provided of a fifth aspect of the embodiments of the present disclosure.

As illustrated in FIGS. 1A, 1, 4, and 8, an image forming apparatus (e.g., the image forming apparatuses 100 and 100A) includes a fixing device (e.g., the fixing device 40). The fixing device includes a fixing rotator (e.g., the fixing rotator 40a), an opposed rotator (e.g., the opposed rotator 40b), a heater (e.g., the heater 40c), and a nip formation pad (e.g., the nip formation pad 40d). The image forming apparatus further includes a sensor (e.g., the sensors 960), a data retriever (e.g., the data retrieval unit 404), an abnormality detector (e.g., the abnormality detector unit 405), an abnormality type determiner (e.g., the abnormality type determination unit 406), and a machine controller (e.g., the machine control unit 411).

The opposed rotator is disposed opposite the fixing rotator to form a nip (e.g., the fixing nip 40e) therebetween. The heater heats the fixing rotator. The nip formation pad is disposed inside the fixing rotator. The heater is disposed opposite the fixing rotator and is disposed opposite an inner circumferential face or an outer circumferential face of the fixing rotator. The heater heats the fixing rotator in an outboard span of the fixing rotator, that is disposed outboard from the nip in a rotation direction (e.g., the rotation direction D40a) of the fixing rotator. The fixing device fixes an unfixed image on a recording medium (e.g., the transfer sheet P) conveyed through the nip.

The sensor detects a temperature of the fixing rotator or the opposed rotator. The data retriever retrieves time series data obtained by collecting sensor values output from the sensor over time. The abnormality detector detects an abnormality of the sensor based on the time series data retrieved by the data retriever and a predetermined rule that is determined in advance. In a case that the abnormality detector detects the abnormality, the abnormality type determiner inputs the time series data retrieved by the data retriever to a learned model and obtains information indicating a type of the abnormality from the learned model. The learned model defines the time series data as input data and the information indicating the type of the abnormality as output data. The machine controller controls operation of the image forming apparatus based on the information indicating the type of the abnormality obtained by the abnormality type determiner.

A description is provided of a sixth aspect of the embodiments of the present disclosure.

As illustrated in FIGS. 1A and 1, according to the fifth aspect, the heater includes a laminated heater that heats the inner circumferential face of the fixing rotator.

A description is provided of a seventh aspect of the embodiments of the present disclosure.

As illustrated in FIG. 8, according to the fifth aspect, the image forming apparatus further includes a machine learning unit (e.g., the machine learning unit 414) that performs machine learning of a dataset that correlates the time series data retrieved from the sensor to the information indicating the type of the abnormality of the image forming apparatus so as to generate the learned model.

A description is provided of an eighth aspect of the embodiments of the present disclosure.

As illustrated in FIG. 7, an anomaly detection method is performed by an electronic apparatus (e.g., the image forming apparatuses 100 and 100A). The anomaly detection method includes retrieving time series data obtained by collecting sensor values output from a sensor (e.g., the sensors 960) over time and detecting an abnormality based on the retrieved time series data and a predetermined rule that is determined in advance. The anomaly detection method further includes inputting the retrieved time series data to a learned model in a case that the abnormality is detected and obtaining information indicating a type of the abnormality from the learned model. The learned model defines the time series data as input data and the information indicating the type of the abnormality as output data. The anomaly detection method further includes controlling operation of the electronic apparatus based on the obtained information indicating the type of the abnormality.

According to the first aspect to the eighth aspect described above, the data retriever, the abnormality detector, the abnormality type determiner, the communicator, and the machine controller are implemented by processing circuitry including the CPU 901. The information processing device is implemented by processing circuitry including the CPU 501 or 901.

Accordingly, the electronic apparatus, the anomaly detection system, and the anomaly detection method address the abnormality to be overcome instantly and suppress redundant downtime.

The above describes the embodiments applied with the technology of the present disclosure. However, application of the technology of the present disclosure is not limited to the embodiments described above. The embodiments of the present disclosure are modified or applied within the scope of the present disclosure and defined properly according to the embodiments that are modified or applied.

According to the embodiments described above, the image forming apparatus 100 is a printer. Alternatively, the image forming apparatus 100 may be a copier, a facsimile machine, a multifunction peripheral (MFP) having at least two of copying, printing, scanning, facsimile, and plotter functions, an inkjet recording apparatus, or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An electronic apparatus comprising:
a sensor to output sensor values; and
processing circuitry configured to:
retrieve time series data obtained by collecting the sensor values from the sensor over time;
detect an abnormality based on the retrieved time series data and a predetermined rule determined in advance;
input the retrieved time series data to a learned model that defines the time series data as input data and information indicating a type of the abnormality as output data;
obtain the information indicating the type of the abnormality from the learned model; and
control operation of the electronic apparatus based on the information indicating the type of the abnormality.

2. The electronic apparatus according to claim 1,
wherein, in a case that the processing circuitry detects the abnormality, the processing circuitry is configured to interrupt operation of the electronic apparatus.

3. The electronic apparatus according to claim 2,
wherein, in a case that the processing circuitry determines that the information indicating the type of the abnormality indicates an abnormality of the electronic apparatus, the processing circuitry is configured to interrupt operation of the electronic apparatus.

4. The electronic apparatus according to claim 3,
wherein, in a case that the processing circuitry determines that the information indicating the type of the abnormality indicates an abnormality resulting from usage of the electronic apparatus, the processing circuitry is configured to resume operation of the electronic apparatus.

5. The electronic apparatus according to claim 1, further comprising a fixing device to fix an unfixed image on a recording medium,
the fixing device including:
a fixing rotator;
an opposed rotator disposed opposite the fixing rotator to form a nip between the fixing rotator and the opposed rotator; and
a heater disposed opposite the fixing rotator, the heater to heat the fixing rotator,
wherein the sensor detects a temperature of one of the fixing rotator and the opposed rotator, and
wherein the processing circuitry is configured to detect the abnormality of the sensor.

6. The electronic apparatus according to claim 5, further comprising a nip formation pad disposed inside the fixing rotator.

7. The electronic apparatus according to claim 5,
wherein the heater is disposed opposite one of an inner circumferential face and an outer circumferential face of the fixing rotator, and
wherein the heater heats the fixing rotator in an outboard span of the fixing rotator, the outboard span disposed outboard from the nip in a rotation direction of the fixing rotator.

8. The electronic apparatus according to claim 7,
wherein the heater includes a laminated heater to heat the inner circumferential face of the fixing rotator.

9. The electronic apparatus according to claim 5,
wherein the processing circuitry is configured to perform machine learning of a dataset that correlates the time series data retrieved from the sensor to the information indicating the type of the abnormality of the electronic apparatus so as to generate the learned model.

10. An anomaly detection system comprising:
an information processing device to generate a learned model; and
an electronic apparatus including:
a sensor to output sensor values; and
processing circuitry configured to:
retrieve time series data obtained by collecting the sensor values from the sensor over time;
detect an abnormality based on the retrieved time series data and a predetermined rule determined in advance;
send the time series data to the information processing device in a case that the processing circuitry detects the abnormality;
input the time series data to the learned model that defines the time series data as input data and information indicating a type of the abnormality as output data;
obtain the information indicating the type of the abnormality from the learned model; and
control operation of the electronic apparatus based on the information indicating the type of the abnormality.

11. An anomaly detection method performed by an electronic apparatus, the anomaly detection method comprising:
retrieving time series data obtained by collecting sensor values output from a sensor over time;
detecting an abnormality based on the retrieved time series data and a predetermined rule determined in advance;
inputting the retrieved time series data to a learned model that defines the time series data as input data and information indicating a type of the abnormality as output data;
obtaining the information indicating the type of the abnormality from the learned model; and
controlling operation of the electronic apparatus based on the obtained information indicating the type of the abnormality.
